(19) United States
(12) Patent Application Publication
(10) Pub. No.: US 2023/0110562 A1
(43) Pub. Date: Apr. 13, 2023

(54) PUSH-PULL TAB TRANSCEIVER MODULE WITH INTEGRATED WIRELESS TRANSMISSIONS FOR OUT-OF-BAND MANAGEMENT

(71) Applicant: Dell Products L.P., Round Rock, TX (US)

(72) Inventors: Padmanabhan NARAYANAN, Redmond, WA (US); Arun DHARMALINGASWAMY, Kanyakumari District (IN); Dhanasekaran THANGAVEL, Chennai (IN); Raghava Krishna JAGARLAPUDI, Prakasam District (IN)

(73) Assignee: Dell Products L.P., Round Rock, TX (US)

(21) Appl. No.: 17/500,535

(22) Filed: Oct. 13, 2021

(51) Int. Cl. H04B 1/3805; H04L 12/931; H04W 88/06

(52) U.S. Cl. CPC H04B 1/3805; H04L 49/45; H04W 88/06

(57) ABSTRACT

A module may include a transceiver and a wireless interface. The transceiver may be configured to communicatively couple to an in-band communications interface of an information handling system and communicatively couple to a cable thus enabling in-band communications via wire-line transmissions between the cable and the in-band communications interface. The wireless interface may be configured to communicatively couple to an out-of-band communications interface of the information handling system and communicatively couple to a client device configured to perform out-of-band management of the information handling system via wireless transmissions between the wireless interface and the out-of-band communications interface.

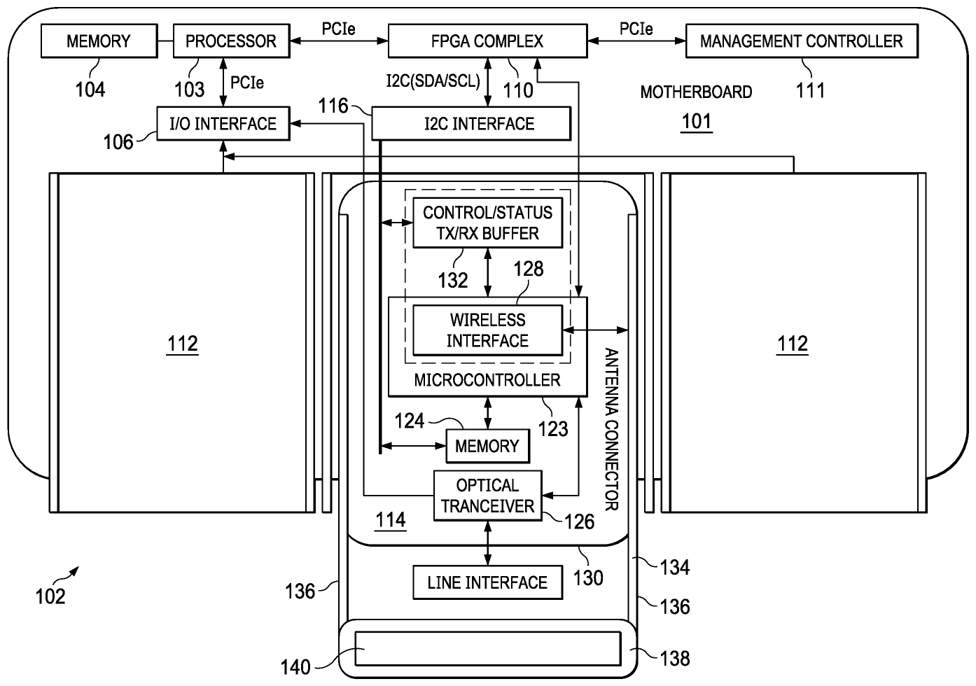

### TECHNICAL FIELD

The present disclosure relates in general to information handling systems, and more particularly to systems and methods for providing a transceiver with integrated wireless transmission module for out-of-band management of a network switch or other information handling system.

### BACKGROUND

As the value and use of information continues to increase, individuals and businesses seek additional ways to process and store information. One option available to users is information handling systems. An information handling system generally processes, compiles, stores, and/or communicates information or data for business, personal, or other purposes thereby allowing users to take advantage of the value of the information. Because technology and information handling needs and requirements vary between different users or applications, information handling systems may also vary regarding what information is handled, how the information is handled, how much information is processed, stored, or communicated, and how quickly and efficiently the information may be processed, stored, or communicated. The variations in information handling systems allow for information handling systems to be general or configured for a specific user or specific use such as financial transaction processing, airline reservations, enterprise data storage, or global communications. In addition, information handling systems may include a variety of hardware and software components that may be configured to process, store, and communicate information and may include one or more computer systems, data storage systems, and networking systems.

An information handling system may have a network interface or other input/output (I/O) interface configured to receive an optical transceiver module (e.g., a small form-factor pluggable (SFP) transceiver or a quad small form-factor pluggable (QSFP) transceiver of any I/O speed). Such transceiver modules often plug into “cages” disposed on an I/O interface card, which often reside in the rear of the information handling system. One of skill in the art will appreciate that this disclosure is also applicable to Direct Attach Cable (DAC) transceiver modules in addition to the other types of transceiver modules described herein.

Often it is desirable to perform out-of-band management of an information handling system. Out-of-band management typically takes place via a communications channel separate from an “in-band” network channel that an information handling system may use to communicate with other networked information handling systems. The out-of-band management channel is typically accessed from a remote management console and/or client device configured for and authenticated to access the out-of-band channel, thus allowing an administrator with management access to an information handling system to perform various management tasks, including diagnostics, firmware updates, configuration, security tasks, etc.

In traditional approaches, switches often include a dedicated port for out-of-band management. However, such approach may have many disadvantages. For instance, such dedicated management port may undesirably take up physical space within a switch that could otherwise be eliminated to reduce a physical size of the switch or otherwise used for other functionality. Further, such dedicated management ports often have low bandwidth. In addition, such dedicated management ports may require connectivity to a management console via a network of other information handling systems, such that faults in the network may cause the managed information handling system to be inaccessible by the management console.

### SUMMARY

In accordance with the teachings of the present disclosure, the disadvantages and problems associated with out-of-band management of a switch or other information handling system may be reduced or eliminated.

In accordance with embodiments of the present disclosure, a module may include a transceiver and a wireless interface. The transceiver may be configured to communicatively couple to an in-band communications interface of an information handling system and communicatively couple to a cable thus enabling in-band communications via wire-line transmissions between the cable and the in-band communications interface. The wireless interface may be configured to communicatively couple to an out-of-band communications interface of the information handling system and communicatively couple to a client device configured to perform out-of-band management of the information handling system via wireless transmissions between the wireless interface and the out-of-band communications interface.

In accordance with these and other embodiments of the present disclosure, a method may include housing, within a housing of a transceiver module, a transceiver configured to communicatively couple to an in-band communications interface of an information handling system and communicatively couple to a cable thus enabling in-band communications via wire-line transmissions between the cable and the in-band communications interface. The method may also include housing, within the housing, a wireless interface configured to communicatively couple to an out-of-band communications interface of the information handling system and communicatively couple to a client device configured to perform out-of-band management of the information handling system via wireless transmissions between the wireless interface and the out-of-band communications interface.

Technical advantages of the present disclosure may be readily apparent to one skilled in the art from the figures, description and claims included herein. The objects and advantages of the embodiments will be realized and achieved at least by the elements, features, and combinations particularly pointed out in the claims.

It is to be understood that both the foregoing general description and the following detailed description are examples and explanatory and are not restrictive of the claims set forth in this disclosure.

### BRIEF DESCRIPTION OF THE DRAWINGS

A more complete understanding of the present embodiments and advantages thereof may be acquired by referring to the following description taken in conjunction with the accompanying drawings, in which like reference numbers indicate like features, and wherein:

THE FIGURE illustrates a diagram of selected components of an example information handling system, in accordance with embodiments of the present disclosure.

### DETAILED DESCRIPTION

Preferred embodiments and their advantages are best understood by reference to THE FIGURE, wherein like numbers are used to indicate like and corresponding parts.

For the purposes of this disclosure, an information handling system may include any instrumentality or aggregate of instrumentalities operable to compute, classify, process, transmit, receive, retrieve, originate, switch, store, display, manifest, detect, record, reproduce, handle, or utilize any form of information, intelligence, or data for business, scientific, control, entertainment, or other purposes. For example, an information handling system may be a personal computer, a personal digital assistant (PDA), a consumer electronic device, a network storage device, or any other suitable device and may vary in size, shape, performance, functionality, and price. The information handling system may include memory, one or more processing resources such as a central processing unit (“CPU”) or hardware or software control logic. Additional components of the information handling system may include one or more storage devices, one or more communications ports for communicating with external devices as well as various input/output (“I/O”) devices, such as a keyboard, a mouse, and a video display. The information handling system may also include one or more buses operable to transmit communication between the various hardware components.

For the purposes of this disclosure, computer-readable media may include any instrumentality or aggregation of instrumentalities that may retain data and/or instructions for a period of time. Computer-readable media may include, without limitation, storage media such as a direct access storage device (e.g., a hard disk drive or floppy disk), a sequential access storage device (e.g., a tape disk drive), compact disk, CD-ROM, DVD, random access memory (RAM), read-only memory (ROM), electrically erasable programmable read-only memory (EEPROM), and/or flash memory; as well as communications media such as wires, optical fibers, microwaves, radio waves, and other electromagnetic and/or optical carriers; and/or any combination of the foregoing.

For the purposes of this disclosure, information handling resources may broadly refer to any component system, device or apparatus of an information handling system, including without limitation processors, service processors, basic input/output systems (BIOSs), buses, memories, I/O devices and/or interfaces, storage resources, network interfaces, motherboards, and/or any other components and/or elements of an information handling system.

For the purposes of this disclosure, circuit boards may broadly refer to printed circuit boards (PCBs), printed wiring boards (PWBs), printed wiring assemblies (PWAs) etched wiring boards, and/or any other board or similar physical structure operable to mechanically support and electrically couple electronic components (e.g., packaged integrated circuits, slot connectors, etc.). A circuit board may comprise a substrate of a plurality of conductive layers separated and supported by layers of insulating material laminated together, with conductive traces disposed on and/or in any of such conductive layers, with vias for coupling conductive traces of different layers together, and with pads for coupling electronic components (e.g., packaged integrated circuits, slot connectors, etc.) to conductive traces of the circuit board.

For the purposes of this disclosure, the term “wire-line transmissions” may be used to refer to all types of electromagnetic communications over wires, cables, or other types of conduits. Examples of such conduits include, but are not limited to, metal wires and cables made of copper or aluminum, fiber-optic lines, and cables constructed of other metals or composite materials satisfactory for carrying electromagnetic signals. Wire-line transmissions may be conducted in accordance with teachings of the present disclosure over electrical power lines, electrical power distribution systems, building electrical wiring, conventional telephone lines, Ethernet cabling (10 baseT, 100 baseT, etc.), coaxial cables, T-1 lines, T-3 lines, ISDN lines, ADSL, and/or any other suitable medium.

For the purposes of this disclosure, the term “wireless transmissions” may be used to refer to all types of electromagnetic communications which do not require a wire, cable, or other types of conduits. Examples of wireless transmissions which may be used include, but are not limited to, personal area networks (PAN) (e.g., BLUETOOTH), local area networks (LAN), wide area networks (WAN), narrowband personal communications services (PCS), broadband PCS, circuit switched cellular, cellular digital packet data (CDPD), radio frequencies, such as the 800 MHz, 900 MHz, 1.9 GHz and 2.4 GHz bands, infra-red and laser.

Examples of wireless transmissions for use in local area networks (LAN) include, but are not limited to, radio frequencies, especially the 900 MHZ and 2.4 GHz bands, for example IEEE 802.11 and BLUETOOTH, as well as infrared, and laser. Examples of wireless transmissions for use in wide area networks (WAN) include, but are not limited to, narrowband personal communications services (nPCS), personal communication services (PCS such as CDMA, TMDA, GSM) circuit switched cellular, and cellular digital packet data (CDPD), etc.

THE FIGURE illustrates a diagram of selected components of an example information handling system 102, in accordance with embodiments of the present disclosure. In some embodiments, information handling system 102 may be a personal computer (e.g., a desktop computer or a portable computer). In other embodiments, information handling system 102 may comprise a storage server for archiving data. In yet other embodiments, information handling system 102 may comprise a server. In further embodiments, information handling system 102 may comprise a network switch.

As depicted in the FIGURE, information handling system 102 may include a motherboard 101 with a plurality of components electrically and mechanically mounted thereto. Motherboard 101 may comprise a circuit board configured to provide structural support for one or more information handling resources of information handling system 102 and/or electrically couple one or more of such information handling resources to each other and/or to other electric or electronic components external to information handling system 102.

As also shown in the FIGURE, motherboard 101 may have mounted thereto a processor 103, a memory 104 communicatively coupled to processor 103, an input/output (I/O) interface 106 communicatively coupled to processor 103 (e.g., via a Peripheral Component Interconnect Enhanced (PCIe) interface), a field-programmable gate-array (FPGA) complex 110 communicatively coupled to processor 103, a management controller 111 communicatively coupled to processor 103 via FPGA complex 110, an Inter-Integrated Circuit (I2C) interface 116 communicatively coupled to FPGA complex 110, and a plurality of optical ports 112 communicatively coupled to processor 103 via I/O interface 106 and communicatively coupled to FPGA complex 110 (e.g., both “directly” and via I2C interface 116).

Processor 103 may include any system, device, or apparatus configured to interpret and/or execute program instructions and/or process data, and may include, without limitation, a microprocessor, microcontroller, digital signal processor (DSP), application specific integrated circuit (ASIC), or any other digital or analog circuitry configured to interpret and/or execute program instructions and/or process data. In some embodiments, processor 103 may interpret and/or execute program instructions and/or process data stored in memory 104, and/or another component of information handling system 102.

Memory 104 may be communicatively coupled to processor 103 and may include any system, device, or apparatus configured to retain program instructions and/or data for a period of time (e.g., computer-readable media). Memory 104 may include random access memory (RAM), electrically erasable programmable read-only memory (EEPROM), a PCMCIA card, flash memory, magnetic storage, opto-magnetic storage, or any suitable selection and/or array of volatile or non-volatile memory that retains data after power to its associated information handling system 102 is turned off.

I/O interface 106 may comprise any suitable system, apparatus, or device operable to serve as an interface between information handling system 102 and one or more other external devices. For example, in some embodiments, I/O interface 106 may comprise a network interface configured to serve as an interface between information handling system 102 and information handling systems via a network, in which case I/O interface 106 may comprise a network interface card, or “NIC.” In other embodiments, I/O interface 106 may comprise a network processor unit or switching ASIC with packet switching capabilities.

FPGA complex 110 may comprise an FPGA and related components that facilitate communication between processor 103 and management controller 111 and communication between I2C interface 116 and either or both of processor 103 and management controller 111.

Management controller 111 may be configured to provide management facilities for management of information handling system 102. Such management may be made by management controller 111 even if information handling system 102 is powered off or powered to a standby state. Such management may also be made via a management channel distinct from an in-band communications channel via which information handling system 102 communicates with other networked information handling systems. For example, in some embodiments, management controller 111 may include or may be an integral part of a baseboard management controller (BMC) or a remote access controller (e.g., a Dell Remote Access Controller or Integrated Dell Remote Access Controller). In other embodiments, management controller 111 may comprise an enclosure controller. In yet other embodiments, management controller 111 may comprise a chassis management controller.

I2C interface 116 may comprise any system, device, or apparatus to enable communication via any suitable I2C standard. Accordingly, I2C interface 116 may implement a communications bus allowing for serial communication of data with a serial data (SDA) line and for serial communication of a clock signal (SCL).

An optical port 112 may comprise an electrical connector in the form of any suitable combination of a jack, a socket, and/or “cage” for receiving a corresponding connector of an optical transceiver module 114. In some embodiments, optical port 112 may comprise a Small Form-factor Pluggable (SFP) optical port. In other embodiments, optical port 112 may comprise a Quad Small Form-factor Pluggable (QSFP) optical port.

Optical transceiver module 114 may include any system, device, or apparatus that houses and includes an optical transceiver configured to convert an incoming optical signal into an equivalent electrical signal, and communicate such equivalent electrical signal to I/O interface 106, and also configured to receive an electrical signal from I/O interface 106, convert such electrical signal into an equivalent optical signal, and communicate such optical signal as an outgoing optical signal (e.g., via an optical cable, which may be integral to the same assembly as optical transceiver module 114). Optical transceiver module 114 may include an SFP transceiver, a QSFP transceiver, or any other suitable form factor.

In addition to processor 103, memory 104, I/O interface 106, FPGA complex 110, management controller 111, I2C interface 116, and optical ports 112, information handling system 102 may include one or more other information handling resources. Such an information handling resource may include any component system, device or apparatus of an information handling system, including without limitation, a processor, bus, memory, I/O device and/or interface, storage resource (e.g., hard disk drives), network interface, electro-mechanical device (e.g., fan), display, power supply, and/or any portion thereof. An information handling resource may comprise any suitable package or form factor, including without limitation an integrated circuit package or a printed circuit board having mounted thereon one or more integrated circuits.

Optical transceiver module 114 may include any system, device, or apparatus that houses and includes an optical transceiver configured to convert an incoming optical signal into an equivalent electrical signal, and communicate such equivalent electrical signal to I/O interface 106, and also configured to receive an electrical signal from I/O interface 106, convert such electrical signal into an equivalent optical signal, and communicate such optical signal as an outgoing optical signal (e.g., via an optical cable, which may be integral to the same assembly as optical transceiver module 114). Optical transceiver module 114 may include an SFP transceiver, a QSFP transceiver, or any other suitable form factor.

As shown in THE FIGURE, optical transceiver module 114 may include a housing 130 that houses a microcontroller 123, memory 124, optical transceiver 126, and control/status transmit (Tx)/receive (Rx) buffer 132.

Microcontroller 123 may include any system, device, or apparatus configured to interpret and/or execute program instructions and/or process data, and may include, without limitation, a microprocessor, microcontroller, digital signal processor (DSP), application specific integrated circuit (ASIC), or any other digital or analog circuitry configured to interpret and/or execute program instructions and/or process data. In some embodiments, processor 103 may interpret and/or execute program instructions and/or process data stored in memory 124.

As shown in THE FIGURE, microcontroller 123 may include a wireless interface 128 for wireless transmissions. For example, in some embodiments, wireless interface 128 may comprise a 2.4-GHz radio-frequency interface enabled to communicate via BLUETOOTH transmissions. Microcontroller 123 may be integrated with wireless interface 128 to interface with control/status transmit Tx/Rx buffer 132 to enqueue/de-queue messages over the radio-frequency interface.

Memory 124 may be communicatively coupled to processor 103 and may include any system, device, or apparatus configured to retain program instructions and/or data for a period of time (e.g., computer-readable media). Memory 124 may include RAM, EEPROM, a PCMCIA card, flash memory, magnetic storage, opto-magnetic storage, or any suitable selection and/or array of volatile or non-volatile memory. In particular embodiments, memory 124 may comprise an EEPROM with a Digital Optical Monitoring (DOM) interface. Memory 124 may comprise an I2C slave device to FPGA complex 110 as an I2C master device. In operation, memory 124 may include information regarding transceiver module 114, including identifying information that indicates the functionality of transceiver module 114. For example, based on information stored in memory 124 and retrieved by processor 103 (e.g., via FPGA complex 110 and I2C interface 116), processor 103 may determine that transceiver module 114 is enabled for out-of-band management via wireless transmissions (e.g., determine that transceiver module 114 has a BLUETOOTH Low-Energy (BLE) interface).

Control/status transmit Tx/Rx buffer 132 may include any system, device, or apparatus configured to implement a buffer to enable communication between FPGA complex 110 and wireless interface 128. For example, control/status transmit Tx/Rx buffer 132 may present BLE control and status information, and transmit/receive buffers (e.g., first-in/first-out buffers) for messaging. Control/status transmit Tx/Rx buffer 132 may comprise an I2C slave device to FPGA complex 110 as an I2C master device. In some embodiments, control/status transmit Tx/Rx buffer 132 may comprise a BLE interface.

Optical transceiver 126 may include any system, device, or apparatus configured to receive an incoming optical signal (e.g., via a Multi-Fiber Push-on (MPO) cable or other suitable cable), convert the incoming optical signal into an equivalent electrical signal, and communicate such equivalent electrical signal to I/O interface 106 (e.g., via optical port 112), and also configured to receive an electrical signal from I/O interface 106 (e.g., via optical port 112), convert such electrical signal into an equivalent optical signal, and communicate such optical signal as an outgoing optical signal (e.g., via the same cable). Accordingly, optical transceiver 126 may provide a line interface for in-band communications between information handling system 102 and other information handling systems.

As also shown in THE FIGURE, optical transceiver module 114 may include a mechanical pull tab 138 mechanically coupled to housing 130 via handles 136 extending from housing 130. Pull tab 138 may provide a user with a mechanical advantage in order to remove optical transceiver module 114 from optical port 112 and/or insert optical transceiver module 114 into optical port 112.

As further shown in THE FIGURE, pull tab 138 may house an antenna 140 therein. Antenna 140 may be implemented with a printed circuit board and may be communicatively coupled to wireless interface 128 via a cable 134 housed within or running adjacent to a handle 136, thus enabling wireless interface 128 to communicate via wireless transmissions with a client device (e.g., a handheld computing device) configured to perform out-of-band management operations of information handling system 102. In some embodiments, the wireless transmissions may be between similar transceivers plugged into one or more network switches to exchange peer liveliness and/or stacking/backplane/switch health status.

As used herein, when two or more elements are referred to as “coupled” to one another, such term indicates that such two or more elements are in electronic communication or mechanical communication, as applicable, whether connected indirectly or directly, with or without intervening elements.

This disclosure encompasses all changes, substitutions, variations, alterations, and modifications to the example embodiments herein that a person having ordinary skill in the art would comprehend. Similarly, where appropriate, the appended claims encompass all changes, substitutions, variations, alterations, and modifications to the example embodiments herein that a person having ordinary skill in the art would comprehend. Moreover, reference in the appended claims to an apparatus or system or a component of an apparatus or system being adapted to, arranged to, capable of, configured to, enabled to, operable to, or operative to perform a particular function encompasses that apparatus, system, or component, whether or not it or that particular function is activated, turned on, or unlocked, as long as that apparatus, system, or component is so adapted, arranged, capable, configured, enabled, operable, or operative. Accordingly, modifications, additions, or omissions may be made to the systems, apparatuses, and methods described herein without departing from the scope of the disclosure. For example, the components of the systems and apparatuses may be integrated or separated. Moreover, the operations of the systems and apparatuses disclosed herein may be performed by more, fewer, or other components and the methods described may include more, fewer, or other steps. Additionally, steps may be performed in any suitable order. As used in this document, “each” refers to each member of a set or each member of a subset of a set.

Although exemplary embodiments are illustrated in the figures and described below, the principles of the present disclosure may be implemented using any number of techniques, whether currently known or not. The present disclosure should in no way be limited to the exemplary implementations and techniques illustrated in the drawings and described above.

Unless otherwise specifically noted, articles depicted in the drawings are not necessarily drawn to scale.

All examples and conditional language recited herein are intended for pedagogical objects to aid the reader in understanding the disclosure and the concepts contributed by the inventor to furthering the art, and are construed as being without limitation to such specifically recited examples and conditions. Although embodiments of the present disclosure have been described in detail, it should be understood that various changes, substitutions, and alterations could be made hereto without departing from the spirit and scope of the disclosure.

Although specific advantages have been enumerated above, various embodiments may include some, none, or all of the enumerated advantages. Additionally, other technical advantages may become readily apparent to one of ordinary skill in the art after review of the foregoing figures and description.

To aid the Patent Office and any readers of any patent issued on this application in interpreting the claims appended hereto, applicants wish to note that they do not intend any of the appended claims or claim elements to invoke 35 U.S.C. § 112(f) unless the words “means for” or “step for” are explicitly used in the particular claim.

What is claimed is:

1. A module, comprising:
a transceiver configured to:
communicatively couple to an in-band communications interface of an information handling system; and
communicatively couple to a cable thus enabling in-band communications via wire-line transmissions between the cable and the in-band communications interface; and
a wireless interface configured to:
communicatively couple to an out-of-band communications interface of the information handling system; and
communicatively couple to a client device configured to perform out-of-band management of the information handling system via wireless transmissions between the wireless interface and the out-of-band communications interface.

2. The module of claim 1, wherein the transceiver is an optical transceiver.

3. The module of claim 1, wherein the information handling system is a network switch.

4. The module of claim 1, wherein the wireless interface is a BLUETOOTH Low Energy interface.

5. The module of claim 1, further comprising:
a housing configured to house the transceiver and the wireless interface;
a pull tab mechanically coupled to the housing and configured to provide a mechanical advantage to a person to enable the person to insert the module into a corresponding port of the information handling system and remove the module from the corresponding port, wherein the pull tab is configured to house an antenna; and
a cable electrically coupled between the wireless interface and the antenna.

6. The module of claim 5, further comprising a handle mechanically coupled between the housing and the pull tab.

7. The module of claim 6, wherein the cable is housed within the handle.

8. The module of claim 6, wherein the cable runs adjacent to the handle.

9. A method, comprising:
housing, within a housing of a transceiver module, a transceiver configured to:
communicatively couple to an in-band communications interface of an information handling system; and
communicatively couple to a cable thus enabling in-band communications via wire-line transmissions between the cable and the in-band communications interface; and
housing, within the housing, a wireless interface configured to:
communicatively couple to an out-of-band communications interface of the information handling system; and
communicatively couple to a client device configured to perform out-of-band management of the information handling system via wireless transmissions between the wireless interface and the out-of-band communications interface.

10. The method of claim 9, wherein the transceiver is an optical transceiver.

11. The method of claim 9, wherein the information handling system is a network switch.

12. The method of claim 9, wherein the wireless interface is a BLUETOOTH Low Energy interface.

13. The method of claim 9, further comprising:
mechanically coupling a pull tab to the housing wherein the pull tab is configured to provide a mechanical advantage to a person to enable the person to insert the module into a corresponding port of the information handling system and remove the module from the corresponding port;
housing an antenna within the pull tab; and
electrically coupling a cable electrically coupled between the wireless interface and the antenna.

14. The method of claim 13, further comprising mechanically coupling a handle between the housing and the pull tab.

15. The method of claim 14, further comprising housing the cable within the handle.

16. The method of claim 14, further comprising running the cable adjacent to the handle.
